(19) United States
(12) Patent Application Publication
(10) Pub. No.: US 2014/0136733 A1
(43) Pub. Date: May 15, 2014

(54) SYSTEM AND METHOD FOR THE COLLABORATIVE RECORDING, UPLOADING AND SHARING OF MULTIMEDIA CONTENT OVER A COMPUTER NETWORK

(71) Applicant: UmiCam Incorporated, Honolulu, HI (US)

(72) Inventor: Martin R.M. Dunsmuir, Waianae, HI (US)

(73) Assignee: UmiCam Incorporated, Honolulu, HI (US)

(21) Appl. No.: 14/078,441

(22) Filed: Nov. 12, 2013

Related U.S. Application Data
(60) Provisional application No. 61/725,714, filed on Nov. 13, 2012.

(51) Int. Cl. H04L 29/08

(52) U.S. Cl. CPC H04L 67/1095
USPC 709/248

(57) ABSTRACT

A method and system for providing multimedia content to a user is described. The multimedia content may include a plurality of multimedia items. The method includes receiving the multimedia items, and determining whether the overlap(s) exist between the multimedia items. This determination is made using discrete Fourier transform(s) (DFTs) of audio data for each multimedia item. The method also includes storing the multimedia items in a file store.

### CROSS-REFERENCE TO RELATED APPLICATIONS

This application claims the benefit of provisional Patent Application Ser. No. 61/725,714, filed Nov. 13, 2012, entitled A SYSTEM AND METHOD FOR THE COLLABORATIVE RECORDING, UPLOADING AND SHARING OF MULTIMEDIA CONTENT OVER A COMPUTER NETWORK, assigned to the assignee of the present application, and incorporated herein by reference.

### BACKGROUND

Today many people are connected to the Internet via their mobile phones. These phones (so-called ‘smartphones’) are powerful computing platforms and can support a variety of powerful applications. All smartphones are equipped with a camera, microphone and applications for the local capture and storage of audio, video and digital photographs. Smartphones also include location detection as a standard feature. It is therefore possible for applications to know where they are located. However, smartphones typically have different original equipment manufacturers and may have different cellphone and internet service providers.

Smartphones typically include applications software to enable multimedia items to be copied or uploaded to a server or desktop computer, from where they can be organized and/or shared with others. The destination of these uploads is often a large public, social networking website, such as Facebook. It is becoming common for users to upload digital photographs and video to a public website, direct from their phones over the wireless network. However, uploading such content may be time-consuming and difficult.

Even if the user succeeds in uploading their content to a public website much effort must be expended to organize and share that content with others. Generally the uploaded items are shared one at-a-time and not as a folder. Even if a service provides for the grouping of multiple items of content into folders it is often difficult and cumbersome for multiple users to contribute content to a single folder and therefore these folders generally represent the recordings made by one user only.

Once content has been uploaded to a public website it is generally associated only with that website and users who wish to view the content must be members of that website or, at the very least, able to navigate through a public interface to find the content. The content may thus be inaccessible to some individuals who the user wishes to view the content. Since content viewing is often only one of many functions of a public website, the content is often surrounded by additional interfaces which can be confusing and detract from the viewing experience.

One of the limitations in using your phone as a video camera is that the length of videos is severely limited by their file size. Video files are typically about 10 Mb per minute or more in size. Not only can these files quickly fill phone storage but they can also be next to impossible to upload over the wireless network because it takes too long to avoid interruptions and errors. Solo recordings, made with the standard camera application on a phone are generally associated with little or no meta-data, such as time or location of creation or keywords and certainly there is no agreement on a standard set of tags which must be set. This makes searching for content difficult and as time passes the original context of recordings and any association between multiple recordings is lost or forgotten. These limitations are further barriers for sharing content captured on a smartphone.

In addition, there may be differences between system clocks. For example two phones may be used to shoot video simultaneously and it would be desirable to know the exact clock offsets between the phones and a third server to which they were uploaded. Many applications, such as online, realtime, multiplayer computer games depend upon knowledge of the clock difference between each player's system and a central hub server. Thus, it is desirable to know the difference between the system clocks on two computer systems (e.g. smart phones) connected by a computer network.

Further, a mobile phone or tablet, may be connected to a server over the mobile data network. However, this network may have a large and variable latency. This latency may be several seconds on some mobile networks. Consequently, it may not be just a simple matter of one system requesting the time from the other system to determine the clock difference. Conventional methods exist for estimating latency and thereby estimating the clock skew between the two systems. However, such conventional methods make assumptions about the nature of the up-bound and down-bound latencies. These assumptions may be purely guesswork and may not accurately represent the realities of the systems and networks involved.

### BRIEF SUMMARY OF THE INVENTION

A method and system for providing multimedia content to a user is described. The multimedia content may include a plurality of multimedia items. The method includes receiving the multimedia items, and determining whether the overlap(s) exist between the multimedia items. This determination is made using discrete Fourier transform(s) (DFTs) of audio data for each multimedia item. The method also includes storing the multimedia items in a file store. In some aspects, the system includes a file store, a post processing module and at least one web server. The file store is for storing the multimedia items. The post processing module processes the multimedia items after they are uploaded to the system. The post processing module also determines whether at least one overlap exists between the multimedia items utilizing discrete DFT(s) of audio data for each multimedia item in the plurality of multimedia items.

### BRIEF DESCRIPTION OF SEVERAL VIEWS OF THE DRAWINGS

FIG. 1. Overview of the Invention: A schematic illustrating a portion of the components of an exemplary embodiment of the invention.

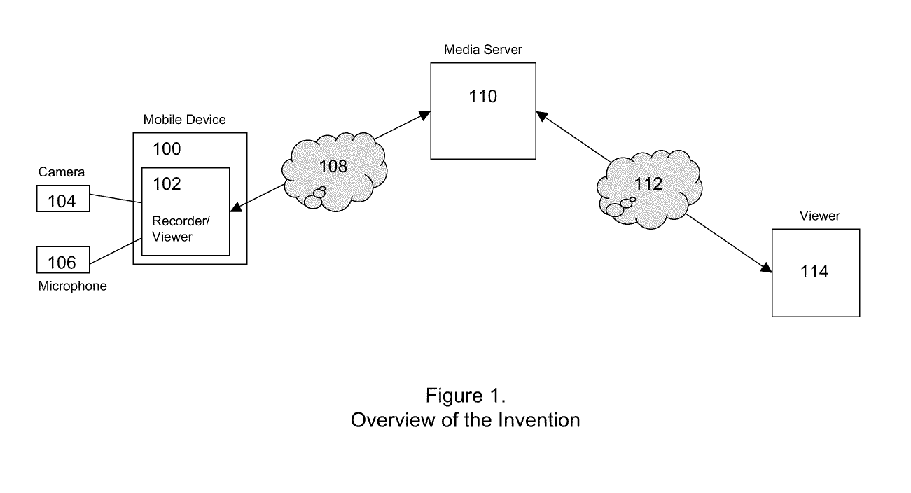

FIG. 2. Component Structure of an Exemplary Embodiment: A schematic illustrating internal components of an exemplary embodiment of the invention.

FIG. 3. Detailed structure of the MPA: A schematic illustrating internal components of the Mobile Phone Application (MPA) component of an exemplary embodiment of the invention.

FIG. 4. Detailed structure of the MS: A schematic illustrating internal components of the Media Server (MS) component of an exemplary embodiment of the invention.

FIG. 5. Event mode Flow Chart: A flowchart of an exemplary embodiment of a method for starting up and running the MPA in event mode.

FIG. 6. Upload Process Flow Chart: A flowchart of an exemplary embodiment of a method for the upload process on the MPA.

FIG. 7. Upload Post-processing Flow Chart: A flowchart of an exemplary embodiment of a method for post-processing items once they have been upload from the MPA to the MS.

FIG. 8. Finding Overlapping Items Flow Chart: A flowchart of an exemplary embodiment of a method for finding time overlapping items within a folder.

FIG. 9. Finding video Synchronization Points: A flowchart of an exemplary embodiment of a method for finding the synchronization point of two overlapping videos.

FIG. 10. A Schematic Diagram of overlapping video: A schematic diagram of various situations which may arise during the process of finding the synchronization point between two videos.

FIG. 11. Representative Synchronization Graphs: Some examples of correlation vs. offset graphs for overlapping videos.

FIG. 12. The MPA Create Folder View: A screenshot of one embodiment of the Create Folder view as displayed by an exemplary embodiment of the MPA.

FIG. 13. The Web Folder View: A screenshot of one embodiment of the online Folder view as displayed by an exemplary embodiment of the MS.

FIG. 14. The Viewing window: A screenshot of the item viewing windows as displayed by an exemplary embodiment of the MS.

FIG. 15. Viewing overlapping items: A screenshot of one embodiment of an online Folder containing overlapping items, as displayed by an exemplary embodiment of the MS.

FIG. 16. Viewing all your Recordings: A screenshot of one embodiment of the ‘My Recordings’ Folder, as displayed by an exemplary embodiment of the MS.

FIG. 17. The Event List: A screenshot of one embodiment of the Event View, as displayed by an exemplary embodiment of the MS.

FIG. 18. The Web Create/Edit Folder View: A screenshot of one embodiment of the Create Event View as displayed by an exemplary embodiment of the MS.

### DETAILED DESCRIPTION OF THE EXEMPLARY EMBODIMENTS

The present invention relates to methods and systems for collaborative recording, uploading and sharing of multimedia content. The following description is presented to enable one of ordinary skill in the art to make and use the invention and is provided in the context of a patent application and its requirements. Various modifications to the exemplary embodiments and the generic principles and features described herein will be readily apparent. The exemplary embodiments are mainly described in terms of particular methods and systems provided in particular implementations. However, the methods and systems will operate effectively in other implementations. Phrases such as “exemplary embodiment”, “one embodiment” and “another embodiment” may refer to the same or different embodiments. The embodiments will be described with respect to systems and/or devices having certain components. However, the systems and/or devices may include more or less components than those shown, and variations in the arrangement and type of the components may be made without departing from the scope of the invention. The exemplary embodiments will also be described in the context of particular methods having certain steps. However, the method and system operate effectively for other methods having different and/or additional steps and steps in different orders that are not inconsistent with the exemplary embodiments. Thus, the present invention is not intended to be limited to the embodiments shown, but is to be accorded the widest scope consistent with the principles and features described herein.

As will be appreciated by one of ordinary skill in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider. Program code embodied on a computer readable medium may be transmitted using any appropriate medium, including but not limited to wireless, wireline, optical fiber cable, RF, etc., or any suitable combination of the foregoing.

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The present invention is directed to a system and method for the collaborative recording, uploading and sharing of audio, video and digital images over a computer network, such as a wireless Internet connection. One implementation of this invention is directed to a mobile phone application and online service connected to it over a wireless computer network.

One embodiment of the invention allows multiple people to simultaneously use their phones to capture images, narrated slideshows and videos. The method and system may show users a list of shared folders based on their location and may automatically upload newly recorded items to the selected shared folder, from where they become visible as a website on PC's or mobile devices. The method and system may automatically find and display overlapping recordings. The method and system may thus allow multiple users to contribute recordings to the same folder. For example multiple participants at an event may place their recordings in the same folder and be notified when other viewers and contributors make changes to, or comment on any of the content in the folder. The method and system may provide a readily available list of folders, including those created by the users' friends. Then the user could quickly and easily navigate the available content folders. Furthermore the folder list may be generated dynamically based on the user's location and identity. Furthermore the method and system may provide a mechanism for controlling where and when folders appeared on the folder list. Users may thus create new shared folders and publish the content to the folder list direct from the users' phones. The method and system may automatically upload and organize the recordings made on phones into folders, which are associated with a specific topic, venue, event or other heuristic and may have those folders provide for easy navigation and viewing of the content. The folders may then be easily shared with others. The contents of those folders may also be easily viewed by users on their phones or other computing devices, such as tablets or personal computers. In addition the capture devices such as phones tablets, personal computers or other computing devices may record in a format which allows longer video recordings without creating huge files. Files having such a format may be uploaded in a reasonable time. The upload process may also be robust, allowing such uploads to be completed efficiently even in the face or errors and interruptions.

The method and system may also generate standard meta-data automatically based on the time, location and context of the recording (such as the name of the folder in which it resides and the meta-data associated with other items sharing the same folder). Associating recordings for the method and system with such information may address issues with conventional recordings. Conventional recordings, made with the standard camera application on a phone, are generally associated with little or no meta-data, such as time or location of creation or keywords. Currently there is no agreement on a standard set of tags which must be set. This makes searching for content difficult and as time passes the original context of recordings and any association between multiple recordings is lost or forgotten. Thus, organization of content is facilitated.

The method and system may also allow multiple recordings from different perspectives to be synchronized and played back. When multiple users are taking pictures or recording videos at an event it is often the case that recordings are made from different perspectives at the same time. For example, at a wedding reception, multiple videos may be recorded simultaneously during moments such as the entry of the bride and groom, the first dance or the cake cutting. It would be desirable to automatically find these overlapping recordings and play them back to the user in a synchronized form.

In one embodiment of this invention, a mobile phone application (MPA)(200), running on a device such as a smartphone, provides the user with the ability to record, upload and share multimedia content. This multimedia content consists of images, audio, video and meta-data. Content is uploaded from the phone to a network accessible media server (MS) from where it can be streamed or downloaded to viewers running standard playback software, on desktop computers, smartphones or other compatible computing devices.

The MS may provide one or more of a number of application programming interfaces (API's), implemented within a Web Server (WS)(222). The WS may mediate upload, viewing, data management and security communications with the MPA. The MS may also include a file-store (for storing uploaded content), and a database (to help manage content and account data). The WS allows users to view and manage content without the need for the MPA or other application to be installed on their viewing device.

In one embodiment the user creates or selects a destination folder for their recordings using interfaces within the MPA and then any multimedia content they create is automatically uploaded to that folder. Other users of a compatible viewing application (such as a personal computer running a web browser) can be directed to a folder by being sent a link to it. Using this link, users can easily navigate to the folder and view or comment on its content. Any number of MPA users can collaborate in filling a shared folder with content.

The user may begin the process of recording, uploading and sharing by starting the MPA on their smartphone device. In one embodiment, the MPA first determines if it is connected to the network and, if so, performs a login handshake step in communication with the MS over the network. If there is no network connectivity or the server cannot be found, the MPA switches to local recording only until the network again becomes available, when the locally created content is automatically uploaded.

If the network is available when it starts up, the list of available shared folders may be generated dynamically by the MS and displayed to the user. This list may be based upon the physical location and identity of the connecting MPA. The user can select one of these shared folders as the destination for their recordings or, alternatively, then can create a new folder for the content using the functions of the MPA. At startup and periodically thereafter the MPA receives location updates from the system.

When a shared folder is created it is associated with a location and a time period. The creator of the folder may also select how close MPA's must be to the location associated with the folder to see it in their list. Furthermore the shared folder may only appear in the list during the time period chosen by the creator. For example a folder could be created for a party and it might be configured to only appear on MPA's operating within 2 miles of the party and only on the day of the event.

In addition to shared folders, which appear on phones in the public folder list, some embodiments also support private folders, which can be shared directly as links but do not appear in the public folder list. In some embodiments, access to existing content is not restricted in time or location, so long as the user has the link to the content folder. However, it is sometimes the case that the owner of a folder may want to restrict access to the contents. In this case the owner can associate a password with the folder and/or other provide another security mechanism to control this access.

Once the user has selected a folder its contents are displayed by the MPA and the user is presented with an interface which allows them to select various functions using the smartphone interface. One of these functions is ‘record’.

In some embodiments, when the user selects ‘record’, they are given a choice of recording mode. The recording mode can be selected as ‘picture’, ‘video’ or ‘slideshow’. A slideshow is an audio recording with a synchronized sequence of digital images. Slideshow images can either be taken manually by the user (using the MPA user interface), or automatically according to a schedule (e.g. every ten seconds).

If the user selects ‘picture’ as their recording mode then a still camera is presented to them and they can use it to capture a single image by clicking the ‘take picture’ button.

If the ‘video’ or ‘slideshow’ mode is chosen, then a video camera is presented to the user. When the user is ready to start creating content, they touch the ‘record’ button on the MPA camera screen to begin recording. At this point the MPA starts video or audio/image recording on the phone using the standard recording functions (media recorder) provided by the phone supplier.

In addition to the creation of a new picture, video or slideshow, the user may choose to select an existing photo or video from their mobile device (for example a video recorded outside the MPA) as the item they wish to upload.

Once a video or slideshow recording has been completed, an existing item selected, or a picture taken, the MPA communicates meta-data about the item to the media server (MS) and automatically upload the video, audio and/or images to the selected folder on the MS. If there is no network connection with the MS, the data is stored locally for later upload. Once a recording and its meta-data have been successfully uploaded to the MS, the corresponding data may safely be deleted from the recording device by functions within the MPA. Optionally the user may choose for recordings not to be deleted from the phone, in which case they may become accessible to other applications on the device where the MPA is running.

During the uploading process the MPA handles any network connectivity errors or interruptions gracefully (the MPA can interrupt and resume an upload if necessary).

If the user chooses to share his recording by selecting the share function of the MPA and sending the corresponding content identifier (e.g. a link) to a potential audience, then the folder containing the content can be viewed by clicking on the content identifier (a link). Users may be presented with a view of the folder contents represented by a thumbnail image of each item. Users may view content and its meta-data by clicking on the thumbnail associated with a specific item. Views are provided which allow the user to review the meta-data associated with each piece of content, comment on the content or share it with others.

Multiple users may simultaneously view the same folder and content on their smartphones or other viewing device (such as a personal computer equipped with a web browser). Some embodiments have scalable architectures, which may allow content to be viewed by potentially unlimited audiences.

The MS may include functions to allow the MS to convert uploaded data, to a format compatible with standard viewing devices. These formats may be built on industry standards, such as MPEG-4, and their manipulation is straightforward to those of ordinary skill in the art. Therefore, assuming that viewers are using compatible viewing software (which is included as standard in most desktop and smartphone platforms), they are able to view the content.

Once multiple items have been uploaded to a given folder the MS may include functions which scan the contents of the folder and find any overlapping items. Then the user may then be presented with an interface to playback these overlapping items simultaneously. In some embodiments each set of overlapping items is displayed as a thumbnail image (chosen from one of the overlapping items). When the user clicks on one of these thumbnails, the synchronized items are displayed and played back in a grid presented to the user by the WS.

In order to find possible overlapping items in a folder, the timestamps associated with each item, which were generated on the MPA when they were recorded, may be used. In addition each recording is associated with a time offset between the clock on the recording MPA and the MS clock. This offset is used to adjust the timestamps of the recorded items from different devices so that they all use the same clock baseline. Having accurate timestamp data enables overlapping items to be found more successfully and reduces the amount of audio processing required to match them exactly. However it is generally the case that there is enough jitter in the timestamps that some audio processing is required to match the recordings exactly.

In some embodiments, to match two videos exactly, the audio tracks of each are processed to create a series of discrete Fourier transforms (DFTs). These DFTs are repeatedly correlated with each other until the best matching offset between them is determined. The correlation may be performed using a sliding window technique. This offset is then used to control synchronized playback.

There are many applications for the method and system described herein. The method and system lend themselves to any applications which could benefit from allowing multiple users to collaborate to create an aggregated folder of content. Thus, the method and system described herein may also allow multiple users to able to contribute recordings to the same folder. For example multiple participants at an event should be able to place their recordings in the same folder and be notified when other viewers and contributors make changes to, or comment on any of the content in the folder. For example the invention may be used at weddings to allow the guests to create an album of the reception. The invention may also be used by a group traveling together to create a shared album of their experiences. It may be used to create ‘virtual visitor books’ which allow individuals to upload images and videos to a folder only if they are at its location. In emergency situations the invention may be used to gather real-time information from the field and display it on a map. The invention might also be used by field personnel, such as insurance adjusters or realtors, to create folders associated with their job. The method and system described herein may also be used in other situations and for other applications.

In some embodiments, the method and system may facilitate a user navigating through a public interface to find content provided using the method and system described herein. Since content viewing is often only one of many functions of a public website, the content is often surrounded by additional interfaces which can be confusing and detract from the viewing experience. In some embodiments, the method and system may provide a readily available list of folders, including those created by users' friends. Users may quickly and easily navigate the available content folders. Furthermore the folder list may be generated dynamically based on the user's location and identity. A user may be provided with means of controlling where and when folders appeared on the folder list. Users may be able to create new shared folders and publish them to the folder list direct from their phones. In addition, in some embodiments, the recordings made on phones into folders may be automatically uploaded and organized, for example based on a specific topic, venue or event. Those folders provide may allow for easy navigation and viewing of the content. The folders may be easily shared with others. The contents of those folders may be easily viewed by users on their phones or other computing devices, such as tablets or personal computers.

In some embodiments, a format which allows long video recordings without creating huge files and which could therefore be uploaded in a reasonable time may be used. A robust upload process which completes uploads efficiently even in the face or errors and interruptions may also be provided. In some embodiments standard meta-data may be generated and automatically based on the time, location and context of the recording (such as the name of the folder in which it resides and the meta-data associated with other items sharing the same folder). Using the method and system described herein, recordings made from different perspectives at the same time may be synchronized to provide a more realistic view of a particular event. For example, at a wedding reception, multiple videos may be recorded simultaneously during moments such as the entry of the bride and groom, the first dance or the cake cutting. These overlapping recordings may be automatically found and played back to the user in a synchronized form.

Overview

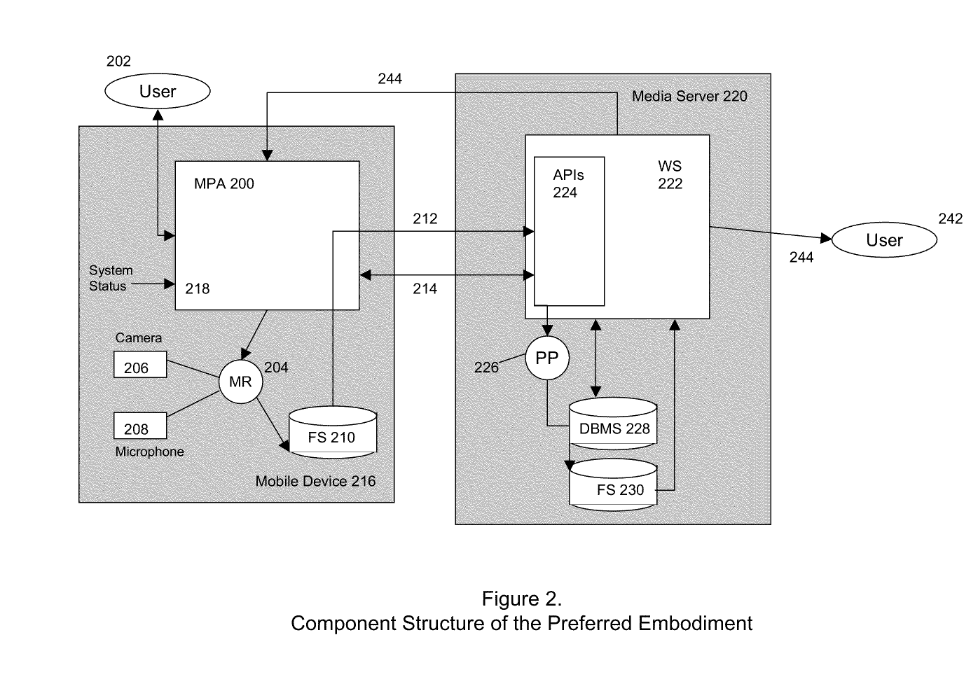

The component structure of an exemplary Embodiment (EE) is shown in FIG. 2. There are three major components in the embodiment shown: the mobile phone application (MPA) (200), the media server (MS) 220 and the Web Server 222. The MPA allows a user to create, share, select and view shared folders, then record and upload content into them. The MS 220 marshals the MPA interface, and stores and serves content. The MS also includes the Web Server 222 which allows users on mobile phones and other computing devices to select, display and share content.

The MPA (200) runs on a mobile device (216) and interfaces with the user (202) through the phone interface (usually a touch screen, plus buttons). The MPA includes a number of sub-components, which interface with the phone's camera (206), microphone (208) and media recorder (MR) (204) through standard system interfaces. Under control of the MR (204) audio, digital photographs and video are captured and stored locally in the file-store (210). This file-store is typically a flash memory device within the phone. There are two sets of client-side network interfaces between the MPA (200) and the MS (220). The upload client-side interface (212) supports file transfer between the MPA and the MS. The MPA also provides client-side interfaces, which support ancillary functions such as: status and location reporting, folder management; security; logging and other housekeeping functions (214). Each MPA instance is logged into an account on the MS, mediated through the interface 214, to identify the creator of content and to ensure that folders and content are correctly marshaled and managed within the MS database (228) and Web-Server (222). The MPA is equipped with event handlers (218) to allow the application to respond to external events, such as a location or network status change.

The Media Server (220) also includes a number of sub-components: a Web-Server (222), serving standard web pages and supporting a set of server-side Application Programming Interfaces (API's) (224) for use by the MPA, a relational database (DBMS) (228), a server File Store (FS) (230) and a content post-processor (PP) (226). The Media Server accepts network connections from MPA's and supports the server-side of the file-upload and ancillary interfaces (212 & 214). The post-processor (226) takes content uploaded over the interface 212 and creates video, image and audio files suitable for delivery to viewers using the Web-Server (222). It also runs the software which finds overlapping videos and pictures and records information in the database (228) which allows overlapping items to be synchronized on playback. Playback may thus be synchronized for multimedia items uploaded from different users' mobile devices controlled and/or obtaining internet access from different companies. All the other components of the MS interface with the database (228) to maintain the status of the system, accounts and content in a single location. The Web Server (222) provides MPA account holders with a user interface for managing their content folders and account information; and provides content viewers with an interface to find and view folders and the content they contain. The web server can serve multimedia content directly from the File-Store (230) to a Media Player embedded in the MPA (200) via the interface (244). The WS interfaces directly with the database (228) and the file-store (230).

Some embodiments do not need an MPA for playback. If content is to be delivered to a non-MPA device the WS relies on providing industry standard video streams, which can be played on many devices, such as smartphones, tablets and desktop computers. In order to support a wide range of devices and desktop configurations, the streams (244) are available in a number of formats simultaneously. The WS streams to MPA users (202) and Web users (242). The preparation of uploaded content into these multiple formats is the function of the post-processing (PP)(226) module, which is described in detail below.

In one embodiment of the present invention the MPA is written in the Java programming language and operates on a smartphone running the Android operating system and the MS is implemented on a PC server running Linux using an Apache Web Server, PHP, C++ and the MySQL relational database. Viewing may be possible on any device which supports the HTML5 video standard. Those of ordinary skill in the art will appreciate that the MPA is not limited to the Android platform and that it could be implemented on a variety of other computing devices. In particular the MPA may be implemented on the Apple iOS platform as well as a variety of other phone or non-phone platforms. For example, a dedicated device could be constructed without a user interface to secretly perform the functions of the MPA via remote control. The MS could be implemented on any platform with sufficient computing power and a suitable network interface.

Detailed Description of the MPA

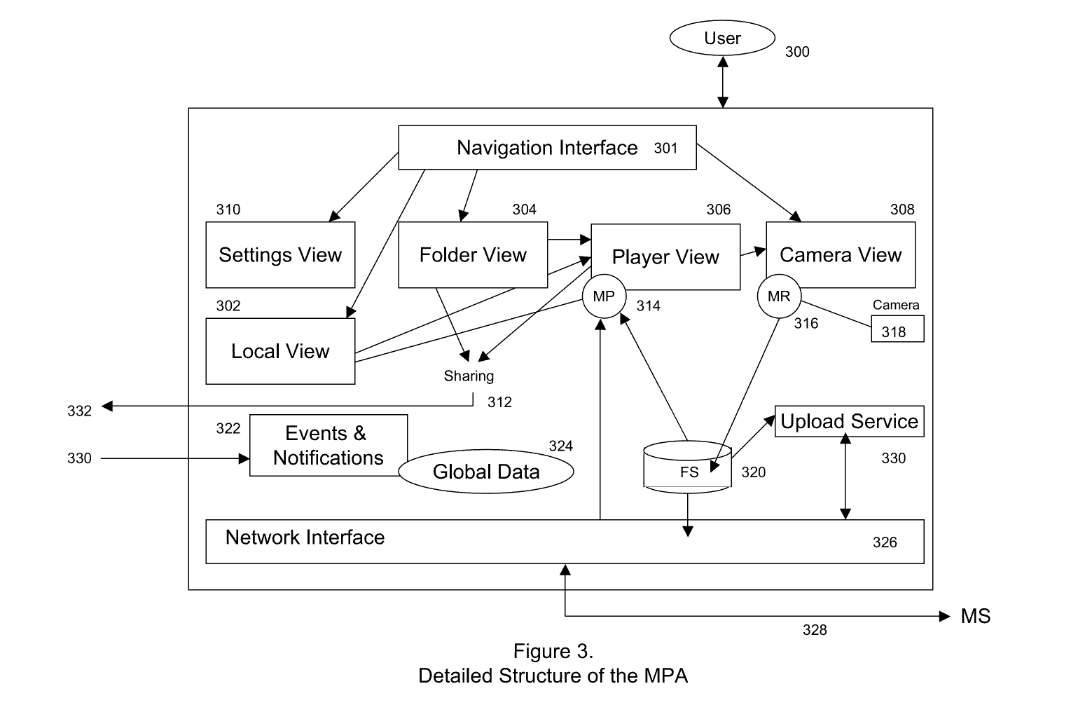

The Mobile Phone Application (MPA) of an exemplary embodiment runs on smartphones running the Android operating system. The structure of one embodiment this application is shown in FIG. 3. The MPA includes a Navigation Interface (301), which gives the user (300) access to a number of different views, each of which is associated with a specific function of the MPA. Views are selected via the Navigation Interface and each View has its own User Interface for interaction with the User. The Navigation Interface includes buttons and underlying menus, which are displayed to the user as the result of touch screen interactions on the phone. The Views include: the Local View (302), which allows the user to select and view content recorded locally (i.e. without a network connection between the MPA and the MS); a Settings View (310), which allows the user to adjust default settings for the MPA running of their phone; the Folder View (304) which allows the user to view and navigate folders and content recordings; the Player View (306), activated from the Folder View, which allows the user to playback and interact with individual recordings using the local media player (314); and the Camera View (308) which allows the user to make new recordings using the media recorder (316) and the phone camera (318). There is also an Upload Service (330), which runs in the background and is responsible for uploading items from the File store (320) to the Media Server. Each View and the Upload Service runs in a separate thread allowing a number of different tasks to proceed in parallel and allowing the user interface to be responsive to the user at all times. Those of ordinary skill in the art will appreciate the value of dividing the work of an application between multiple threads. The embodiment shown makes use of the interfaces and services provided by the underlying operating system to perform its tasks. These include external functions which provide their own user interface, such as: the Media Recorder (316), which is used to capture and record video and digital photographs; the Media Player (314) which is used to playback recordings; and other functions such as the email and text-messaging interfaces (332). When an external event takes place, such as a change to the location of the host device, an event message (330) is sent by the system to the MPA, where an event handler (322) updates global data (324) and notifies interested views of the message's arrival, as appropriate. The global data (324) is accessible to all functions of the MPA and this data is divided into two categories: persistent data, which is maintained across instantiations of the MPA; and volatile data, representing the state of the current MPA instantiation. This latter data is lost when the MPA terminates. In addition to the Views themselves a set of network interfaces (326) is provided to allow the Views to interface with the Media Server over a computer network (328) and the MPA also makes use of the local file-store (320) to store recordings and their meta-data before they are uploaded to the Media Server.

The MPA includes a number of internal functions (312) which allow the user to share content via email, SMS and to common social networking services.

Detailed Description of the Media Server

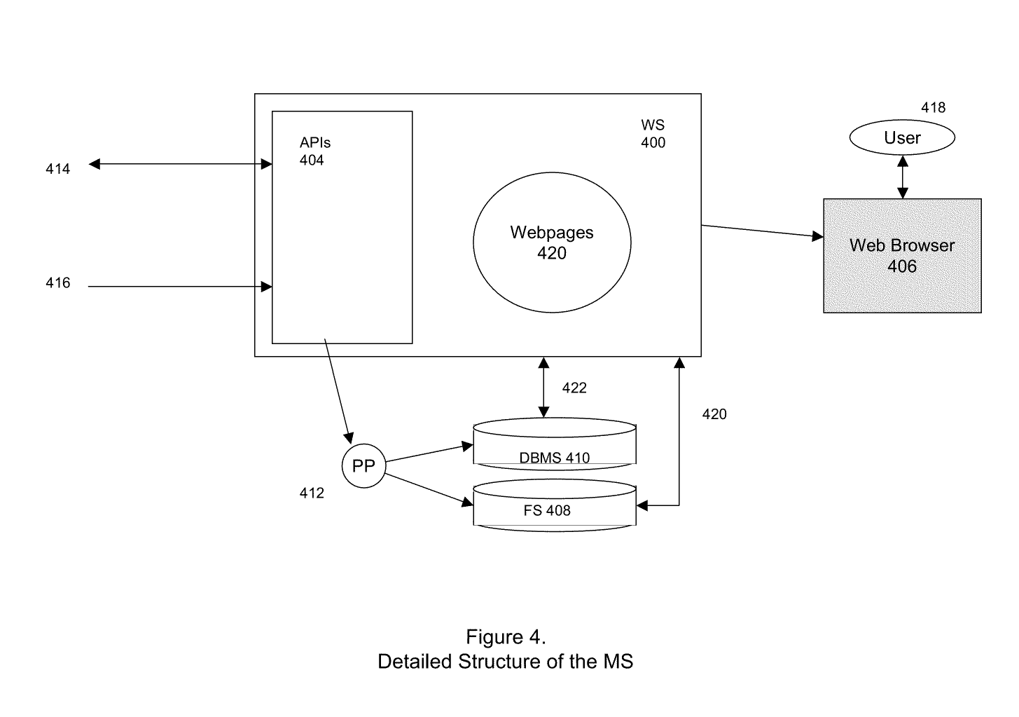

In one embodiment the Media Server (MS) (220) runs on a Linux Server running the Apache Web Server, the MySQL database and the PHP scripting language. This ‘LAMP’ configuration may be familiar to those of ordinary skill in the Art. In addition, in one embodiment, a number of programs and scripts are installed to tie the various components of the Media Server together. The detailed structure of the MS is shown in FIG. 4.

The central component of the Media Server is the Web Server (400). This Web Server mediates the upload interface (416) and the management interface (414) for example by implementing PHP API's (404) to communicate with the MPA (200). The Web Server also serves web pages (420) and multimedia content to the end user (418) via web browsers (406) running within the MPA and other computing devices. There are three other major components of the MS in the embodiment shown—the media post-processor module (412): which translates incoming media into the formats necessary for Web delivery and runs tools over incoming media to identify time overlaps between different recordings and images; the File store (408), where content is stored and marshaled by the MPA; and, the MYSQL database (410) which is used to maintain the state of the Media Server and the content it is managing. This database is called from PHP code running inside the web server and also from scripts and programs, which form the media post-processor (412). The Web Server uses standard system interfaces (420 and 422) to communicate with the File Store and the DBMS.

Using the MPA

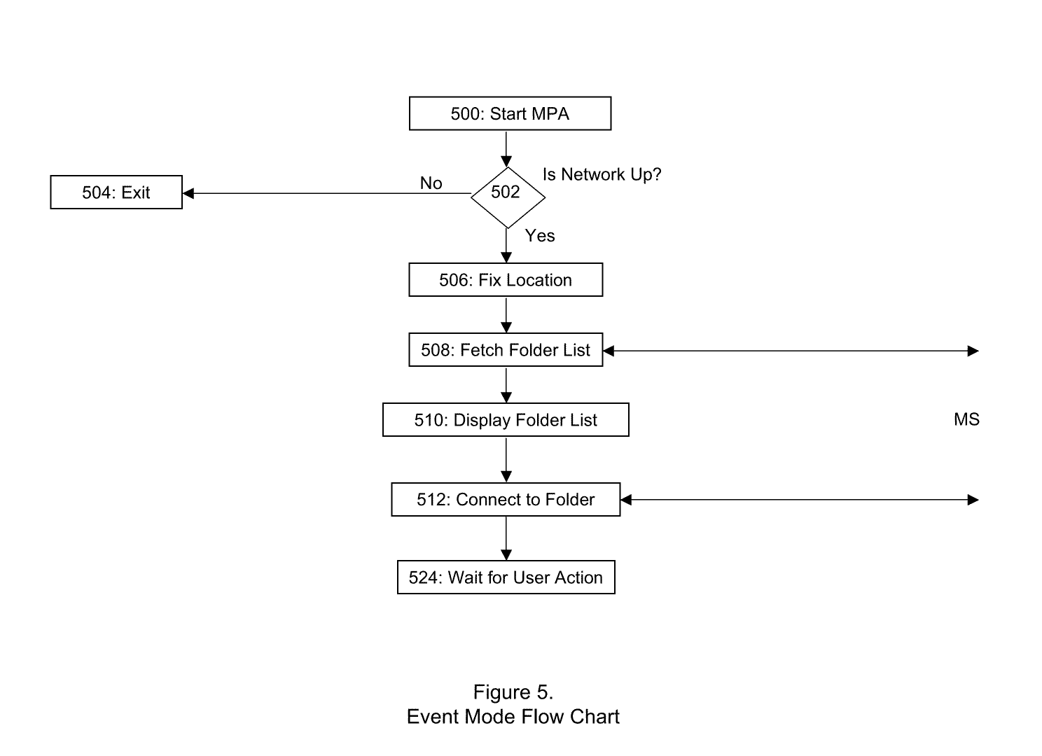

In one embodiment the user downloads the MPA application to their phone from an online store. When first started, the MPA starts running in ‘event’ mode. The flow of control in event-mode is shown in FIG. 5. The MPA starts at step 500. Firstly the application checks to see if the network is available (step 502). If the network is not available and this is the first time it has run, then the application exits at step 504. If the network is not available but this is not the first time the MPA has run, the MPA may enter local recording mode (see below). If the network is available then the MPA obtains a location fix (step 506) and requests a list of shared folders corresponding to the MPA's location (step 508) from the MS via the MS API interface (414). The shared folder list may be presented to the user as a menu of choices at step 510. Once the user chooses a folder the MPA asks the user to choose a name to identify themselves (by default this is the name recorded in the phone's settings); then the MPA logs in as a contributor to that folder (step 512) and presents the contents of that folder within the Folder View (304). The user is then free to choose and action and the MPA therefore waits for that choice (524).

Once the MPA has logged in as a contributor to a folder the MPA remembers this and goes directly to the last folder viewed when the application starts. A menu is provided which lets the user switch between events if they choose.

In event mode the MPA provides a number of functions to the user. These are: select a folder; switch to local recording mode; login to an existing full account; create a full account; take a picture; make a video; choose an existing video or photo; or, create a new folder. A full account is needed if the user wishes to create his/her own folders. A full account, described below, offers the user a number of extra features over and above those offered by the event mode. Each of these functions is accessed via buttons and menus presented on the phone's screen.

If the user chooses to select a folder then the list of folders is obtained from the MS and displayed to the user as a menu of choices. Once the user chooses a folder the MPA logs in as a contributor to that folder and presents the contents of that folder within the Folder View (304).

If the user chooses to switch to local mode then the MPA does not use the network, even if it is connected, and any content created is stored locally on the phone and displayed within the Local View (302). When the user exists local mode they are asked if they want to upload their local recordings. If the answer is yes, then any recordings found in the file store are uploaded to the Media Server.

If the user chooses to login to an existing full account they are asked for their username and password by the MPA. The MPA validates the user's input by sending it to the MS. If the credentials are correct then the application enters full mode, logged in with the user's identity. The MPA remembers the last login and automatically starts in full mode, logged into the user's account.

If the user selects to create an account they are asked by the MPA to choose a username and password. If the username is unique and the password is acceptable then the application enters full mode, logged in with the new user's identity.

If the user chooses to create content, by hitting the camera button on the MPA toolbar, they are given three choices: take a picture, record a video (or slideshow); or select an item from the existing pictures and videos.

If the user chooses to take a picture they are presented with a Camera View (308) and they can take a picture in the normal way. Once they are satisfied they hit an OK button on the Camera interface and the picture is stored locally in the file store (320), along with its meta-data and added to the queue of items to be uploaded. Pictures may require processing to reduce them in size depending upon the user settings (see below). Uploading may not take place immediately, it is managed by the upload service (330), a separate thread, which manages the flow of uploading data dependent upon the network conditions or MPA status. The upload process is described in detail below.

If the user chooses to make a video they are presented with the Video Recorder View. This view is more complex than the Camera View. It provides a number of functions which can be used to choose the recording format or, if their phone has multiple cameras, to switch between them. The recording format can be cycled between video, automatic slideshow and manual slideshow. The user starts and stops recording using a record/stop button and, when they are satisfied, they leave the recorder by selecting an OK button. When the OK button is activated the recording is stored locally in the file store (320), along with its meta-data and added to the queue of items to be uploaded. In addition, if the recording was a video, then a thumbnail frame is extracted from it and forwarded to the MS, so that it can be displayed even when the video has not yet been uploaded.

If the user chooses to select an existing item they are presented with the phone's standard Gallery application and they can browse through the content they have stored on their phone. Once they are satisfied with their selection they hit an OK button meta-data is created for the selected content and the content is tagged for upload to the MS.

Normally upload proceeds immediately following content creation or selection. The MPA uses the MS API (224) to upload content and to manage the database records associated with it. Once an item has been uploaded it will appear in the selected folder and every MPA, which is viewing that folder, is sent a notification message that the folder content has changed. This notification message allows MPA views of a folder to be automatically refreshed when new content arrives. However, in other embodiments, the upload may proceed in another manner.

The Folder View (304) displays a webpage associated with the selected folder and delivered to the MPA by the Web Server (222 & 400). This webpage integrates closely with the MPA application because the MPA uses standard system interfaces to intercept user interactions with the Folder View. In one embodiment, each item in the Folder View is associated with a single picture, video or slideshow. The Folder view supports the following functions when the user clicks on a thumbnail image of an item: view an item or share an item. In addition, buttons are provided on each item, which allow comments to be made or the item deleted (if the user contributed it or owns the folder it is in). Viewing and sharing are discussed in detail below.

If the user chooses to make a comment on an item by clicking the comment button on the screen then they are asked to enter a textual comment, which is displayed next to the commented item, along with their name. It is a system rule that comments can only be deleted by the writer or the owner of the folder or item, containing the comments. The Folder View displays the appropriate delete buttons on content depending on this rule.

Viewing Content

If the user clicks on a thumbnail in the Folder View they are given the option to view the underlying content. The viewing process may involve fetching the selected content from the Media Server. In addition meta-data and other information (such as the number of views of the content and any comments associated with it) are downloaded and may be displayed to the user. Images are downloaded in their entirety and displayed to the user. Videos are streamed from the MS server. Video streaming which is familiar to those skilled in the art, allows playback of the video to start on the MPA without the need to download the whole video to the MPA first. Slideshows are rendered as videos by one embodiment; therefore they are also streamed.

The MS allows multiple MPA's to be connected to the same folder. Therefore multiple users can contribute to the same folder simultaneously.

Sharing Items with Others

It is often the case that users wish to share the folder or item of content they are viewing with others. Some embodiments allow users to share links with others via a number of means, including posting on public websites, emailing or sending an SMS message. The links are formatted such that, when they are executed against the Media Server they result in the display of the content identified by the link. If the user who clicks the link is on their phone with the MPA installed, then the MPA starts and displays the content identified by the link. Otherwise a web browser is used to display the content appropriately on the requesting device.

Local Recording

In situations where there is no network connectivity or the user has chosen not to use the network, the MPA operates in local mode. In local mode the user can create and view content but it is not uploaded to the MS until the user has left local mode and the network connection between the MPA and the MS is operational. The Local View displays the locally recorded items stored on the user's phone and allows them to be viewed and deleted. Local mode allows the MPA to be used, even where the network connection is non-existent or unreliable.

The Format of Uploaded Items

Each item to be uploaded: picture, slideshow, video or other content; may include one or more media files, plus an XML file, which contains the meta-data associated with the item. XML is a standard markup language for describing items, its use if well-known by those skilled in the Art. The item description in the XML file includes the following:

The item identifier (a unique number).

The start time of a video recording or the time when a picture was taken or an item selected. This is a time as taken by the MPA from the phone's internal clock.

The duration of the video or slideshow (not required for photos).

The measured time offset between the MPA clock and the MS clock.

The latitude and longitude of the phone when the item was recorded, if available.

The possible error in the location information expressed as the radius of the error circle surrounding the given location.

The true compass heading of the camera viewpoint at the moment when the first picture was taken or the video recording began.

The destination folder identifier. This controls where the item goes on the MS.

The identity of the contributor.

The item type: photo, slideshow or video.

The height and width in pixels of any images or videos comprising the item.

The identity of the camera used to create the item (some phones have multiple cameras).

Optionally a Title and descriptive text associated with the item and provided by the contributor.

The XML file also includes a record for each media file, which is part of the item. Each record includes the following:

A unique media item identifier.

The name of the file containing the item.

The file's type. Within one embodiment the possible file types are JPEG, MOV, MP4, 3GP, AAC and AMRNB.

The file's size in bytes.

In some embodiments, other information may also be included.

The XML file may contain all the data necessary to setup the database on the MS and to post-process the incoming item correctly. Once the XML file and all the media files associated with an item have been uploaded, the XML file is used to drive the post-processing of the item (see below).

When the MPA starts it checks the file-store (320) to see if there are any items to be uploaded. It does this my scanning the file store and looking for XML files. If XML files are found they are used to direct the upload of any missing portion of the corresponding item.

The Clock Offset

The system knows the exact time when a recording was started or a picture taken or other time which can be used to sync the recording. In the first instance the local clock on the MPA is used to compute this time. However there is often a time discrepancy between the clock on the MPA and the clock on the MS. This discrepancy is accounted for.

At startup and periodically thereafter (every 30 secs in the case of one embodiment) the MPA communicates with the MS to try and determine the offset of the MPA and MS clocks.

The method used by one embodiment to estimate the time offset between the MPA and the MS is as follows: an API is called by the MPA which returns the current value of the MS clock (Ts); the MPA clock time at when Ts is received from the MS (Tm), is also measured; therefore the true offset (O) between the MS and MPA clocks in given by the formula: O=Tm−(Ts+L), where the lag L is the time elapsed between the measurement of Ts on the MS and receipt of Ts on the MPA. The time lag L is unknown but it may be regarded as the sum of two terms: Lf, a fixed time; and, Lv a variable time dependent of the network conditions between the MS and the MPA. I.e. L=Lf+Lv. Lv may be approximated as follows: repeated measurements of the perceived clock difference X are made (X=Tm−Ts) and their standard deviation (S) calculated after each measurement. Heuristically we estimate Lv as being 3×S since Lv must be greater than or equal to zero. We make assumptions about Lf depending on the type of network connection we have between the MS and the MPA. Lf is chosen from a list of fixed values dependent upon the type of network connection. We can therefore estimate L=Lv+Lf and therefore estimate O. The offset O obtained in this way is typically correct to within a few tens of milliseconds, which is sufficient for our purposes.

This time offset O, is generally fixed unless the MPA or MS updates its clock since the rate of drift of both the MPA clock and the MS clocks is generally negligible. The MPA clock, in one embodiment, is updated by the network periodically. This update is detected by the MPA and a new offset measurement is made. Therefore any content created by the MPA has the last measured time offset O included in its meta-data (XML file). This offset is used by the MS to adjust the given start time of an item to coincide with the MS clock. Knowledge of this offset is critical to the efficient operation of the post-processor service (412) on the MS.

Estimating Clock Skew

In one embodiment of the method for estimating clock skew, a mobile device performs a portion of the method, while a server performs another portion of the method. For example, a mobile phone may run a client computer-program product, implementing the client-side of the method. For example, the mobile device 100216 and media server 110/220 or web server 222 may implement portions of the method. This program may communicate over a wireless IP network with a server running a computer-program product which implements the server-side of the method. Both the client and the server have access to their local system clocks. In one embodiment, the client and server can obtain the value of their local system clocks as a UNIX time at millisecond granularity.

A simple interface is implemented between the client and the server. At local time T0 the client sends a time request to the server and includes a guess g as the value of the server's clock when it will be received by the server program. The guess g is T0+O, where O is the client's estimate of the difference between the two clocks. In response, the server sends its system clock time S and the difference between the client's guess and the actual time when it was received G, namely G=g−S. T+O=G+S. Therefore the true value of O can be estimated to be G−O.

Repeated calls are made to the server with the value of O and hence g, adjusted by G each time. By way of this feedback loop, with each iteration, the mean value of O will approach its true value and at the same time the mean value of G will tend to zero.

The client's best estimate of O approaches the true value of O as more samples are taken. However, O includes two parts: K, the true clock skew; and Ls, the latency of the up-bound data transfer. To take Ls out of the equation and determine the true value of K, the mean roundtrip time, R, for our requests is measured. In addition, the mean of the delta D is calculated. The mean value of delta D is the difference between S−O (S having been received in the server response) and T1 (the time when the response was received), D=(S−O)−T1. If the down-bound latency is Lr then, since R=Lr+Ls and 2Ls=D+R. A negative value of D indicates that Lr<Ls. A positive value of D indicates that Ls>Lr. Therefore, D is the difference between 2*Ls and Ls+Lr. As more samples are accumulated our confidence in R, O and D grows. The best estimate of K, the true clock skew is given by the formula: K=O−(R+D)/2. Using the method of the invention it is possible to quickly determine the true clock skew K, to within a few ms.

The Upload Process

As described above, when an item has been recorded it may be added to the queue of items to be uploaded. This queue is held in Global Data Memory (324) and rebuilt by the MPA at startup by searching the MPA file store for items to be uploaded.

In one embodiment the upload server task (330) runs in a separate thread and is responsible for selecting items from the upload queue and sending them to the MS. In addition to the upload of media files the upload server is responsible for sending meta-data (an XML file) concerning each item to the MS and performing other housekeeping functions. The upload server uses the MS API's (414 & 416) to communicate with the MS and to upload files.

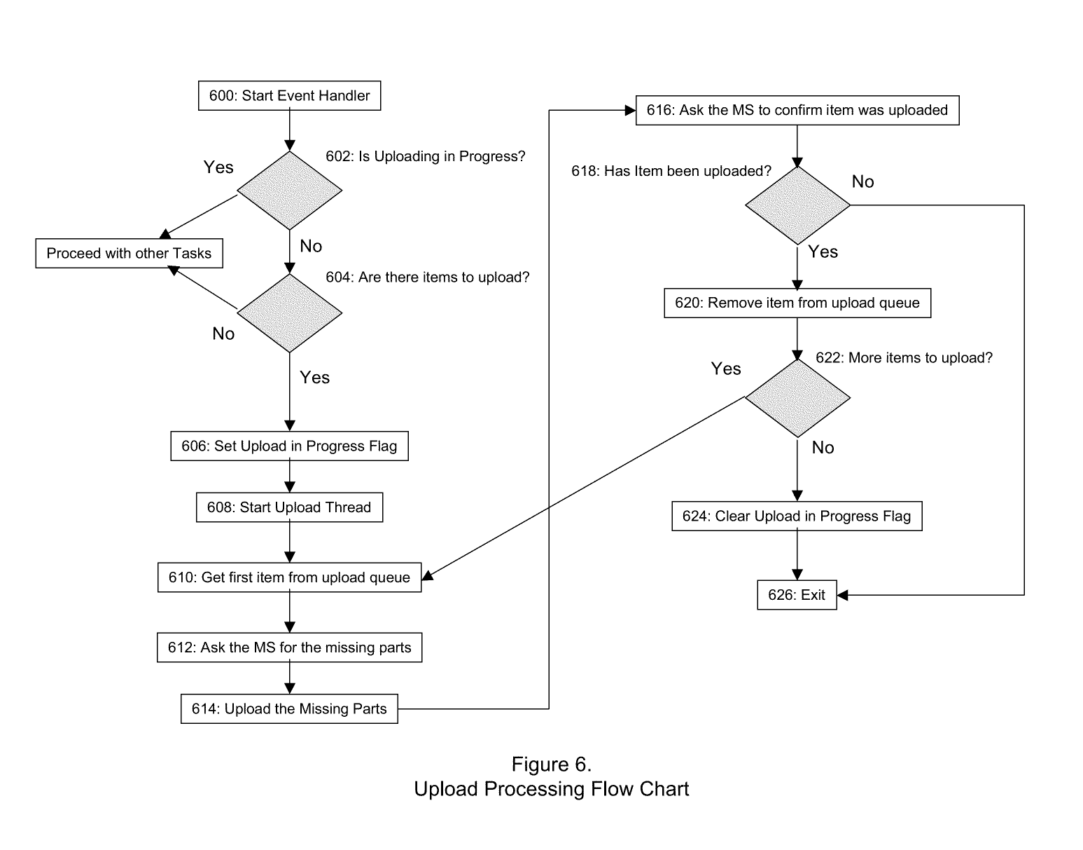

In order to try to ensure that the upload of data always completes, even in the face of multiple interruptions and failures, which can arise in practice, the upload server may be able to recover from error situations and resume uploads without resending data. Furthermore the MS may not proceed with the display or processing of incoming items until all their parts have been uploaded correctly. In order to achieve this API's are provided by the MS. The API's allow the upload server to find out the status of a partially uploaded item and thereby to determine what needs to be uploaded to complete the item. A flowchart of one embodiment of the upload processing is shown in FIG. 6.

Periodically the system sends alarm signals to the MPA. These wake up the MPA Event Handler (322 and step 600) and cause it to be executed. At step 602 the Event Handler checks to see if uploading is in progress by inspecting the upload progress indicator. If uploading is already in progress the Event Handler proceeds with other tasks. If no uploading is in progress the Event Handler checks to see if there are any items to be uploaded (step 604). If there are, the Handler sets the upload in progress indicator, starts the upload thread and proceeds with other tasks (steps 606 and 608).

Once the upload thread starts it takes the first item from the upload queue (step 610) and makes an API call to the MS to ask it which pieces are missing from the item (step 612). In an embodiment in which uploading of the item has not commenced, the MS may indicate that all pieces are missing from the item. Armed with the list of missing items the upload thread finds and uploads all the missing pieces (step 614). Once the upload thread thinks that all the pieces of an item have been uploaded (step 616), it makes a further call to the MS to confirm that the item has uploaded correctly.

If the item has not been uploaded correctly the upload thread leaves the item on the upload queue and terminates (steps 618 & 626). Then, when the upload thread starts again a further upload attempt will be made for the item.

Normally items have been correctly uploaded and the MS will confirm that. If the item has been uploaded correctly then, depending on the user settings (see below), the upload may choose to delete the local copy of an item as well as removing it from the upload queue (step 618). In other embodiments, the upload may not delete the local copy of the item, but still remove the item from the upload queue.

If an item has been successfully uploaded and removed a check is made to see if any items remain on the upload queue (step 618). If there are more items on the queue then steps 610 through 618 are executed until the queue is empty or an error occurs. If the upload queue is empty (step 622) then the upload in progress indicator is cleared (step 624) and the upload thread terminates (step 626).

In one embodiment, when all the files corresponding to an item have been uploaded to the MS the item is post-processed using the post-process service (412). Post processing installs the incoming files for the item in the MS file store (408) and set ups the database (410) with entries corresponding to the new item. Post-processing also includes determining whether the incoming item overlaps in time with any of the other items in the destination folder and, if so, generating synchronization data for them and putting this information in the database. The details of item synchronization are described below.

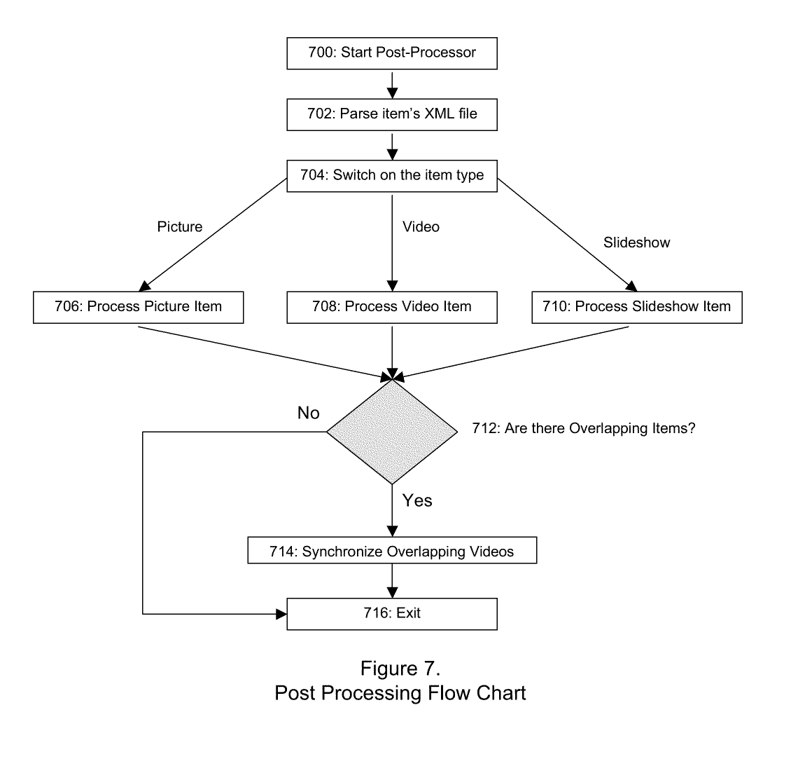

A flowchart of one embodiment of the post-processing service on the MS is shown in FIG. 7. If a file is successfully uploaded from an MPA, a check is made within the API module to determine if every file associated with the item has been uploaded. If this is the case, then the item is post-processed using the post-process service (412). In other embodiments, post-processing may be started based on other events, such as upload of a particular portion of the files for the item completing.

The post-process service starts at step 700. The post-processor starts at step 700. At step 702 the post-processor reads and parses the XML file associated with the item. Then at step 704 the post-processor chooses a course of action dependent on the type of item and the format of its constituent files. The processing depends on the type of item: picture, video or slideshow.

At step 706, if the item is a picture, a thumbnail is generated from the full-size image file, a database entry is created for the item and its presence in the destination folder is noted there also.

At step 708, if the item is a video then the thumbnail image sent by the MPA is installed as a title image for the item, a database entry is created for the item and its presence in the destination folder is noted there also. The video file is processed, for example using standard open source tools, to create copies of the video in all the file formats necessary for playback. In some embodiments these formats are MP4 (with H264 video and AAC audio), OGV (with Theora video and Vorbis audio), and, WEBM format (with Vp8 Video and Vorbis Audio). In one embodiment incoming video format can be 3GP (with H264 video and AMR audio) or MP4 formats (with H264 Video and AAC audio). The audio track is extracted from the Video and rendered as a PCM file in the commonly used WAV file format. This audio file is use in synchronizing overlapping items (see below).

At step 710, if the item is a slideshow then a number of image files have been uploaded. In some cases, an audio file will also have been uploaded. A database entry is created for the item and its presence in the destination folder is noted there also. The first image of the slideshow is processed to create a thumbnail image and then a video is created, using open source tools, from the images and audio. This video file has a very low frame-rate and is therefore uses a considerably smaller file that a full frame-rate video. This video file is processed, for example using standard open source tools, to create copies of the video in all the file formats necessary for playback. In one embodiment these formats are MP4 (with H264 video and AAC audio), OGV (with Theora video and Vorbis audio), and, WEBM format (with Vp8 Video and Vorbis Audio). The audio track of the slideshow is rendered as a PCM file in the commonly used WAV file format. This audio file is use in synchronizing overlapping items (see below). Once s slideshow has been converted to video the MS handles its playback in exactly the same manner as for full frame-rate videos.

Once the item has been processed a check is made at step 712 to see if its timestamp (the start time adjusted by the server time offset) overlaps with any other items in the same folder. If no overlapping items are found, the post-processor exits at step 716. If one or more overlaps are found, then the item is processed to determine the exact synchronization time with the overlapping items. This process is described below. Once this step (714) has been completed or is not necessary then post-process service exits at step 716.

Automatic Synchronization of Overlapping Items.

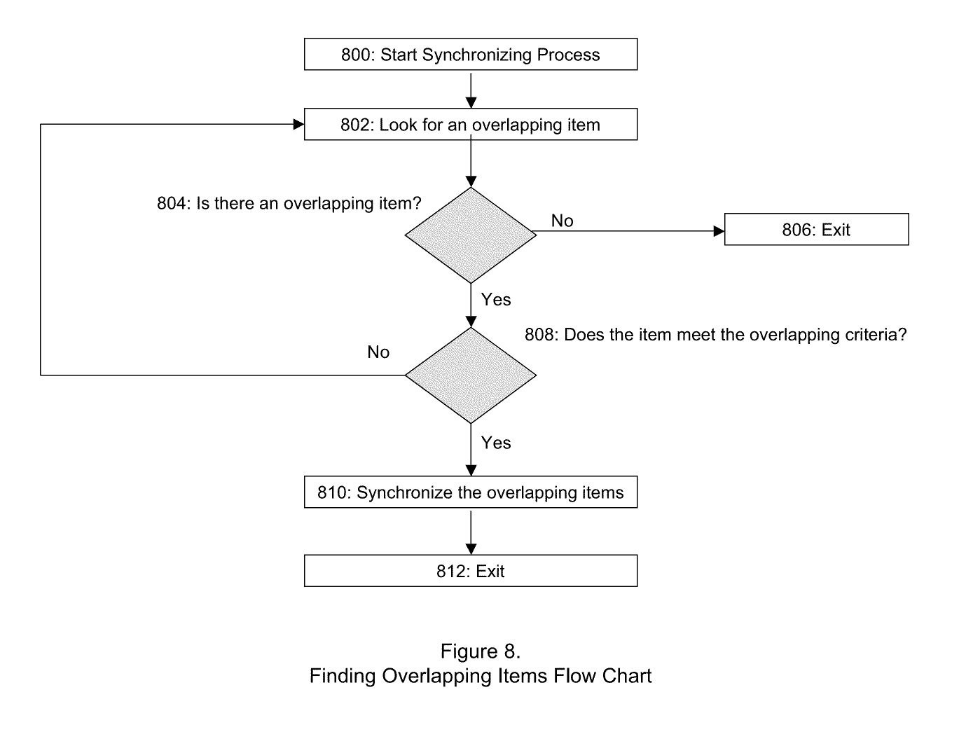

It is often the case that multiple recordings in the same folder overlap in time. Sometimes videos or slideshows overlap and sometimes images were taken during a video or slideshow. In some embodiments, when a new item arrives at the MS the system performs a check to see if the item overlaps with any other items in the same folder. If an overlap is found, then the system processes the overlapping items and generates synchronization data, which is recorded in the database for later use in playing back the items in a synchronized fashion. A flowchart of the overlap detection and synchronization process is shown in FIG. 8.

The synchronization process starts at step 800. First the most recent item overlapping with the incoming item and in its destination folder is identified (step 802). The overlap is determined by comparing the timestamp and duration of the incoming item with the timestamps and durations of the existing items. The timestamps and server time offsets of incoming items are considered valid to within a few seconds although they generally cannot be guaranteed to be sufficiently accurate to be used directly for synchronization. If no overlaps are found (step 804), then the synchronization tool exits at step 806. Potential overlaps are rejected if one or both items are too short or the length of the overlap between the two items is too short for reliable processing.

The incoming item is matched with the most recently preceding and overlapping item; this item is called the reference item. If the overlap criteria mentioned above are met, the two items are processed by a tool developed as part of the exemplary embodiment to find their exact point of synchronization. The start time and other timestamps associated with the incoming item are adjusted to match with the time-base of the reference item exactly to within a single video frame. No processing is necessary for images overlapping with videos but their timestamps are adjusted based on the timestamps of the reference and the timestamps of the image. It would be possible to extend the processing to match images with frames of video.

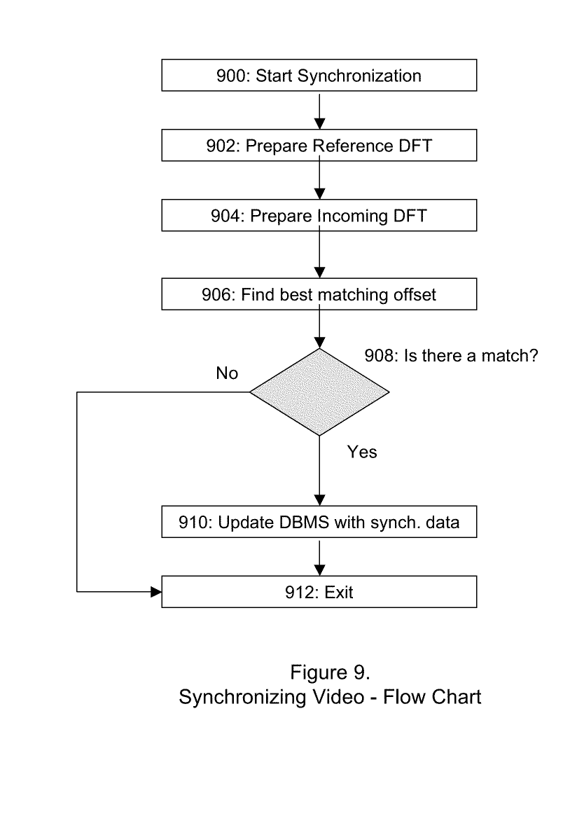

An exemplary embodiment of a method for processing overlapping video files at step 808 is illustrated in FIG. 9. The video files may be uploaded from different mobile devices having different users, different operating systems, and/or different mechanisms to upload to the MS. The processing starts at step 900. At steps 902 & 904 synchronization tool processes the reference and incoming PCM audio files to create an array of Discrete Fourier Transforms (DFT's) for each. Each DFT represents the normalized power spectrum of an audio sample. In one embodiment the length of this audio sample time is 100 ms.

The DFT's in the reference array are correlated with the DFT's in the incoming array. The incoming DFT's are compared in sequence with a corresponding sequence of DFT's in the reference. In one embodiment, the result of this processing is a correlation coefficient, which is a measure of the match between the reference and the incoming audio. The process of matching is repeated with the incoming DFT's moved one step to the right. This action is repeated until a correlation coefficient has been calculated for every position of the incoming DFT's compared with the reference. Unless there is a clear winning offset the best matching offset is chosen based on heuristics applied to the top matching offsets. The result of this process (step 906) yields the true matching offset or it is reported that no matching offset was found. A test is made to see if a matching offset was found (step 908). If no matching offset was found the synchronization process terminates at step 912. Otherwise the meta-data of the incoming item are adjusted in the database to record the exact point of synchronization (step 910) and the synchronization process exits (step 912).

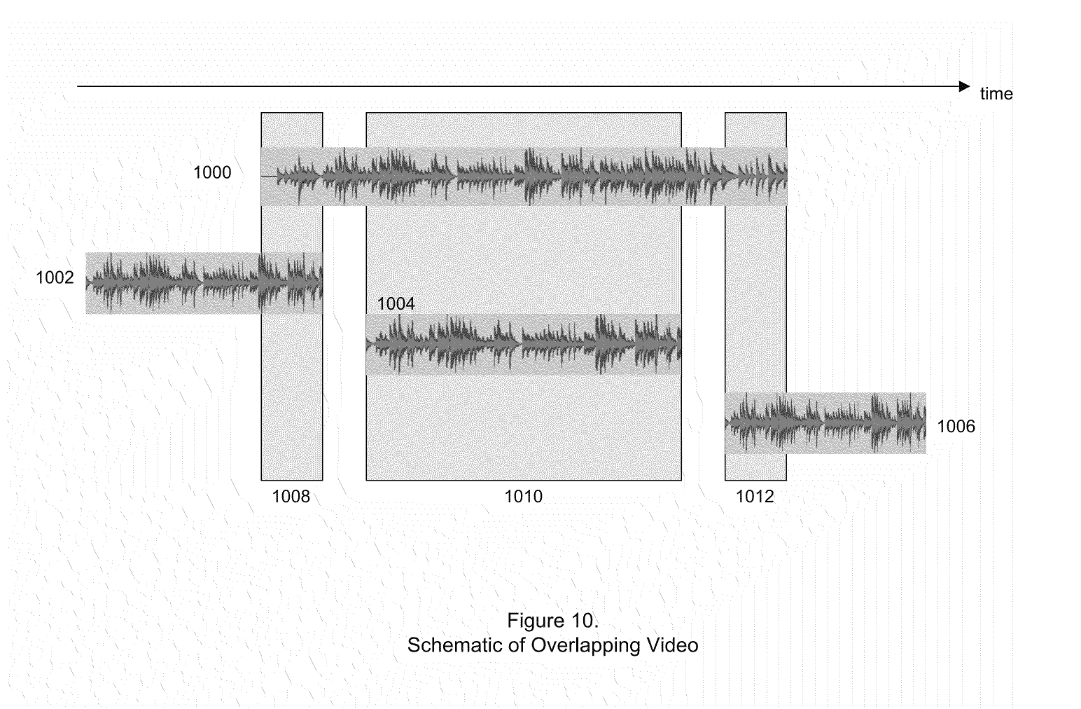

FIG. 10 shows an exemplary embodiment of schematically how the incoming item is compared with the reference item and is moved against the reference to determine correlation as a function of the offset between the reference and the incoming items. The schematic has time going from left to right and the reference (1000) is shown at the top of the figure. The incoming items (1002, 1004 and 1006) are moved stepwise from left to right and the overlapping section between the two items is correlated at each step. The incoming sample position 1002 corresponds with the first point of comparison. In order for the correlation between the two sources to be valid they must overlap by a minimum time L. The width of the overlap L is illustrated (1008 & 1012). In one embodiment L was chosen to be 1 second. In sample position 1004 the incoming item is completely enclosed by the reference and so the whole incoming item is compared against the reference. In this case the overlap encompasses the whole of the incoming item (1010). Sample position 1006 corresponds with the last point of comparison because there is only L seconds of overlap between the two items (1012).

One significant element in the synchronization process is the correlation function, which is used to determine the quality of the match between the reference item and the incoming item at each offset. This coupled with the heuristics applied to choose between the best matches is important to the functioning of the synchronization process.

For each set of audio samples (S) there is a corresponding DFT with S/2 entries. Each entry corresponds to the power in a particular frequency from half the audio sample rate at the high end (typically 8 Khz) down to half the frequency corresponding to the length of the sample interval S.

In one embodiment, the correlation function used to compare two DFTs is to multiply each element in the first by the corresponding element in the second and take the square root of the absolute value of this number. In some embodiments, all DFT's are normalized (they always sum to the same value, called the normalized sum). In such embodiments, the ratio of the sum of the correlations between all the corresponding DFT entries divided by the normalized sum, gives a correlation coefficient between 0 and 1.

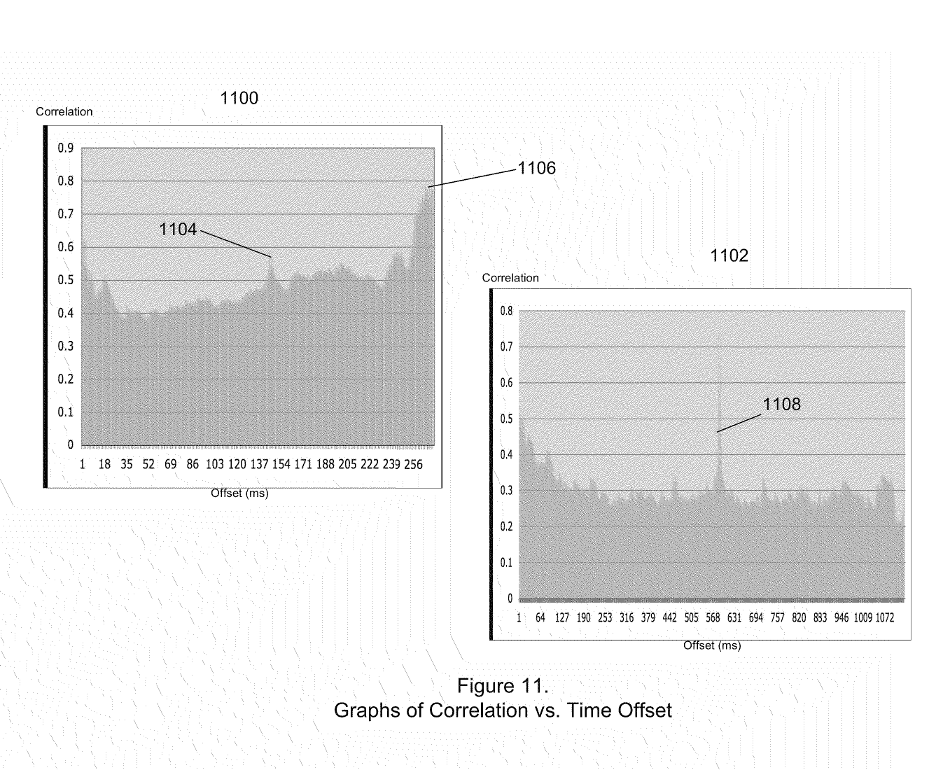

Often however there will be a number of matching points between the reference and the incoming audio. If this case a heuristic may be applied to distinguish the true match from its mimics. In some embodiments, this heuristic is based on the slope of the correlation function near the matching point, which corresponds to a sharp local maximum in the correlation function for a true match. FIG. 11 shows two example graphs of correlation coefficient vs. time offset between reference and incoming items, these two examples are labeled 1100 and 1102. The first trace (1100) has two significant maxima 1104 and 1106. Although the maximum 1106 is the largest it is not the true matching point. Instead, the true matching point is 1104. The system rejects the offset 1106 because its peak is not sharp. Offset 1104 however corresponds to a sharp peak in the correlation and corresponds to the correct matching offset. The graph labeled 1102 in FIG. 11 shows a situation where the matching offset is obvious. There are no maxima approaching the value at point 1108 and that peak is sharp enough to be selected. If no peaks are sharp enough or there are too many similar matching offsets to choose from then the synchronization process is not possible.

Full Mode

When one embodiment is first installed, it is in event mode. In event mode the user only has access to those folders appearing on the folder list and has no account on the MS. However the user may choose to create a new account or login to an existing one. At this point the application is said to be in full mode and additional functions are available to the user. Specifically the user assumes the identity of an account holder and can create and manipulate the set of folders and content items they have created. The user may switch to full mode by choosing ‘login or create account’ from a menu or by selecting the ‘create folder’ function in the event mode view. Once the application has been switched to full mode it remembers the identity of the user and always logs in as the user and enters full-mode at startup. The details of account creation or login are discussed above.

Creating Folders

In some embodiments, a button is provided on the MPA screen, which allows a user to create a new folder. In order to create a new folder the MPA is operating in full mode. Therefore if the user chooses to create a folder in event mode, they are prompted first to create a new account or login. Once they are in full mode, there are two kinds of folders that a user can create: private and public. The private folder has a name and belongs to its creator but it does not appear in the public folder list. Instead the folder is shared with other users and potential contributors via a link, because they are already friends of the creating user, or by some other mechanism used in conjunction with private folders. In one embodiment friends are chosen as those who have accounts on the MS and who are also friends of the user on a particular social network. In full mode the MPA provides a menu where the user can select from their own private folders and the private folders of others that have been shared with them.

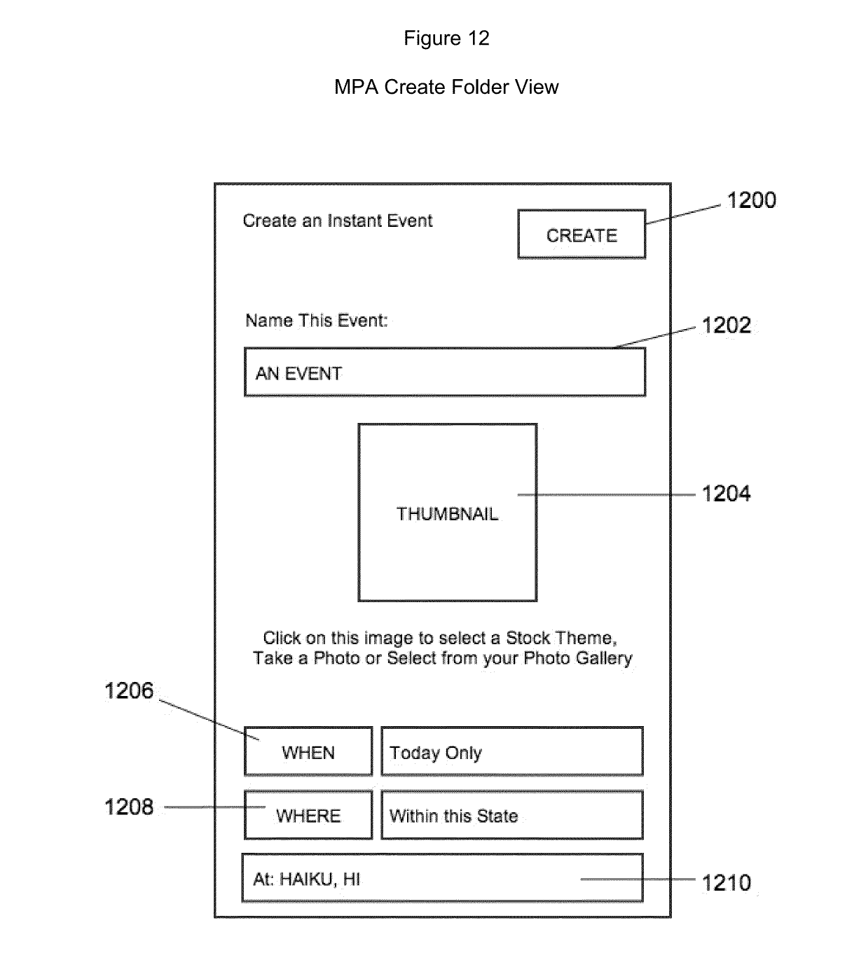

An example of the MPA public folder creation interface in one embodiment is shown in FIG. 12. A similar but much simpler interface may be used to create private folders (private folders are only characterized by their name). The user enters a name for the folder (1202), selects a theme image (1204) by taking a picture, selecting from the local photo gallery, or choosing a stock image. Then the user selects when and where the new folder will be visible in the public folder list (1206 and 1208). For folders created using the MPA they are considered to be at the location of creation, this location is displayed at the bottom of the screen (1210). Normally a City and State are displayed, however some locations have no city associated with them; such locations are displayed as latitude and longitude. On the Web the location of the folder can be separately chosen (see below).

Using the Where selector (1208) the user can select how far away from the creation location users have to be to see the folder in their public folder list on phones. In one embodiment the choices are: nearby (within 1 mile), in the same city (within 10 miles), in the same state (within 500 miles), some other geographic region, or anywhere. The When selection (1206) allows the user to choose when the folder appears in the public folder list (subject to the where restrictions chosen for the folder). One embodiment gives the choices: today only, today and tomorrow, for a week and, for a month to allow the user to choose how long the folder with be visible on phones from the time of creation. The Web folder creation interface (described below) gives the user the ability to specify time periods exactly, including in the future. Once the creation selections have been made, and the folder name chosen, the user selects the ‘create’ button (1200) and an empty folder is created on the MS via an API call.

Once a new folder has been created it immediately appears in the public folder list of eligible users and the creating MPA displays the new folder. Anyone selecting the new folder in the MPA, can immediately add content to it.

Website Functions

A number of user functions are available on the MS Website using a Web Browser. The website is the primary place where content is viewed and it provides a number of functions for account holders who login there. Users use the same username and password to login to the MS website as they do to login to the MPA on their phone.

Viewing Folders on the Web.

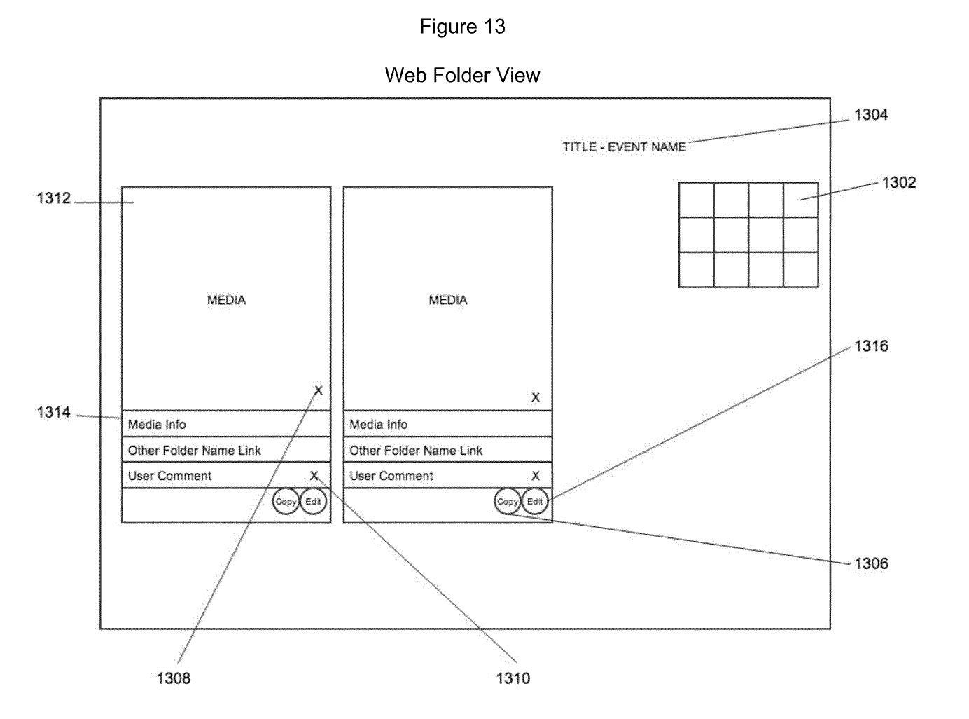

If a user clicks a link to an MS folder or item and they are running a suitable browser on their PC or other device and they do not have the MPA application installed, then they are presented with a web view of the selected content. An example of a typical folder view in one embodiment is shown in FIG. 13. At the top of the screen is the header (1304) which provides information on the selected folder (including how many items it contains and how many times they have been viewed), displays the selected folders theme image and provides buttons and links which allow the user to login, create an account, or select another folder to view. The list of folders displayed by the website is not limited by location, only time. If the user is logged in, then the folder list also includes all the public and private folders belonging to them and others have shared with the user or that they have visited either on the Web or within the MPA. The folder is displayed with the items on the left and a set of thumbnails to allow folder navigation on the right (1302). If an item is in more than one folder, the list of folders is displayed below the item (1314). The user can easily navigate to these other folders by clicking on an item in this list. The website view also provides the user with the ability to view, share and comment on items (1316). If an item is owned by the user viewing it, or the user owns the folder being viewed the user can delete the item or its comments by clicking on one of the delete buttons (1308 & 1310). An item may be viewed or shared by clicking on its thumbnail image (1312).

An additional button may be provided on each item, which allows the user to copy it to any of the folders he can view. When the user clicks this button (1306) a list of possible destination folders is displayed to the user. The item is copied to the folder chosen.

Viewing Items on the Web.

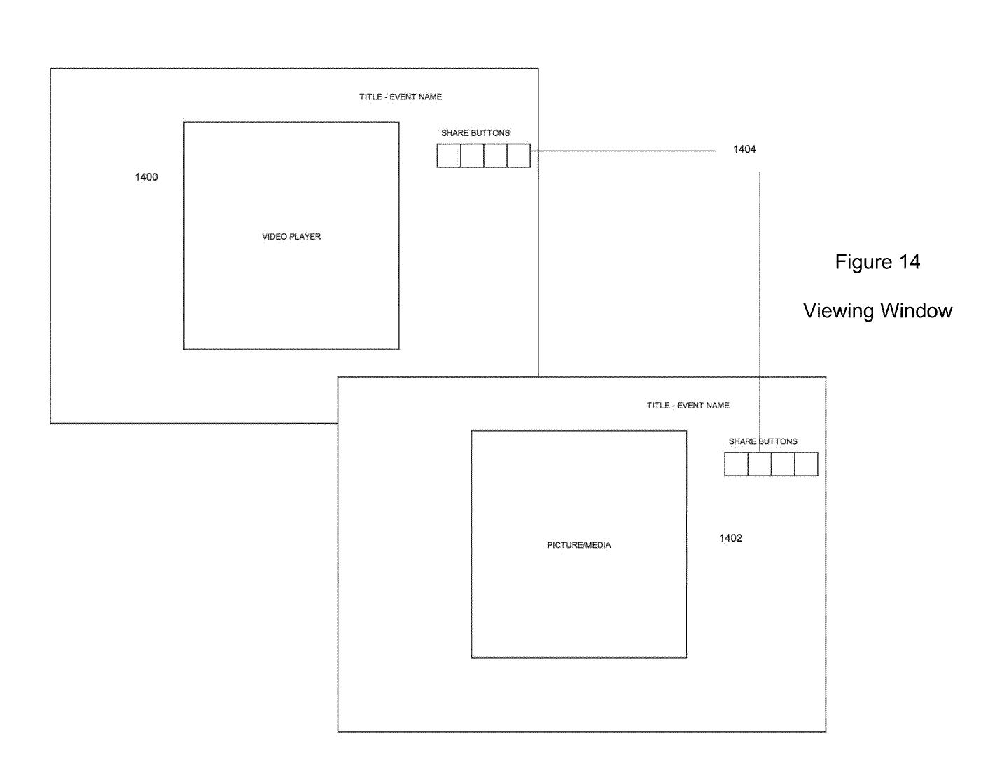

If the user clicks on an item (1312) it opens up in a viewing window. An example of this is shown in FIG. 14. Depending on whether the item is a video (slideshow) or a single picture the viewing window may be configured differently. On the left of FIG. 14 (1400) a video window is shown. The video plays within the designated area and buttons are provided (1404) which allow the user to share a link to the item via email or on the user's social network. A similar view (1402) is provided for pictures.

Viewing Overlapping Items.

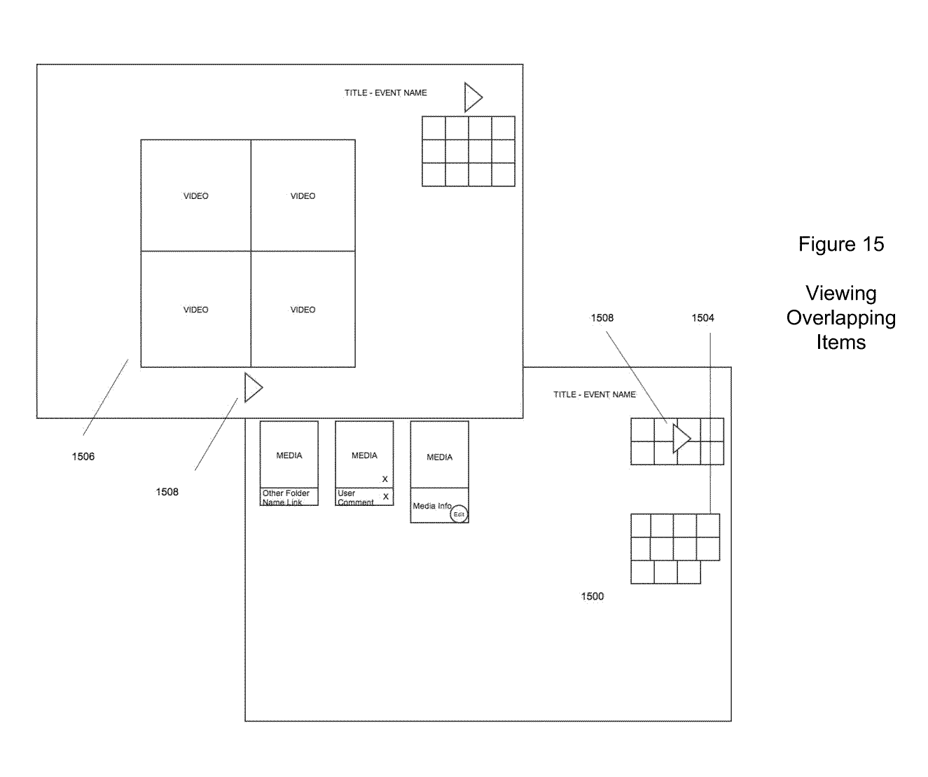

When a folder is displayed in the web browser the MS checks to see if the folder contains any overlapping items. If it does then a set of thumbnails (one per overlapping sequence) is displayed (1502), one per overlapping sequence, above the folder thumbnail display (1504). An example of this is shown for one embodiment in FIG. 15. If an overlapping sequence thumbnail is clicked by the user the selected overlapping sequence is displayed as a wall of images and videos (1506). In one embodiment buttons (1508) are provided at the bottom of the playback window so that the user can control synchronized playback.

If the user clicks the play button (1508) the system plays the videos in the group of overlapping items and times the start and stop of each video and the appearance of each image in line with the synchronization data in the database. The net result is that the user sees the overlapping sequence exactly as it occurred.

Viewing all Your Content

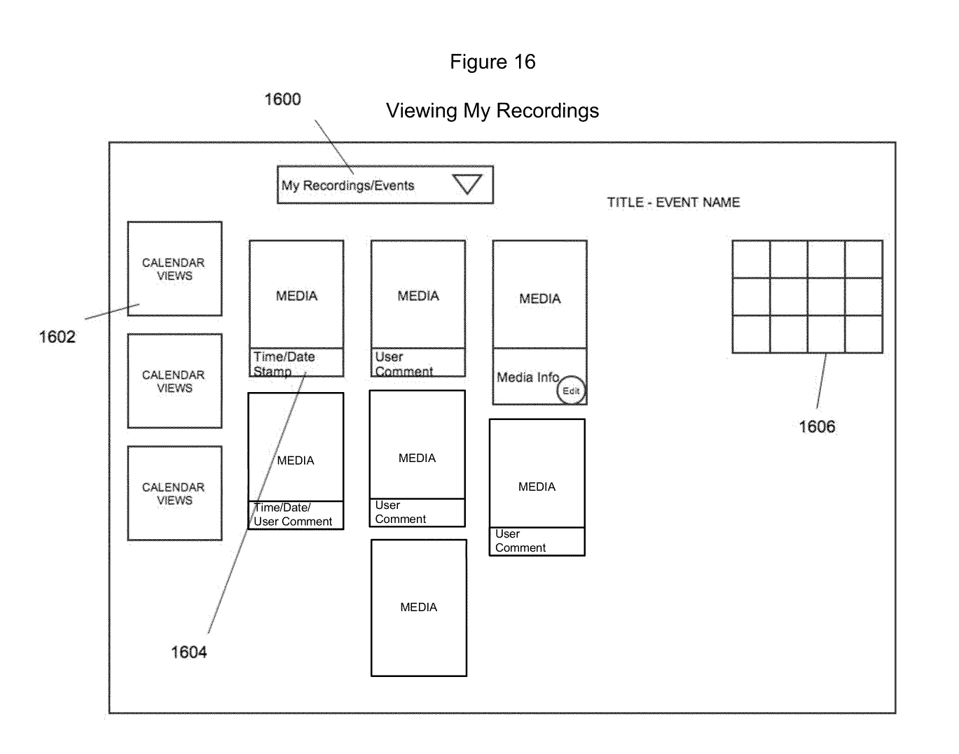

If a user is logged in to their account on the MS, then an additional view may be available to them. This is called the ‘my recording’ view. An example of this view is shown for one embodiment in FIG. 16. The ‘my recording’ view is like the folder view except that the content may be organized by time of creation not by folder (1604). Users soon create more items than comfortably be displayed on one page; therefore the ‘my recording’ view (1600) divides the content into manageable chunks and provides a set of calendar buttons on the left of the screen (1602) to navigate the content month by month. The thumbnail view at right (1606) shows all the recordings made during the selected time period.

Many search methods are possible—for example by location, subject, or folder. In any case each item has a list of the folders containing it attached and therefore the user can easily navigate to those folders directly. Deleting an item in the ‘my recordings’ view may delete it entirely from the system. Deleting an item from a folder only removes it from that folder, it still appears in the ‘my recordings’ view.

Managing and Creating Folders Online.

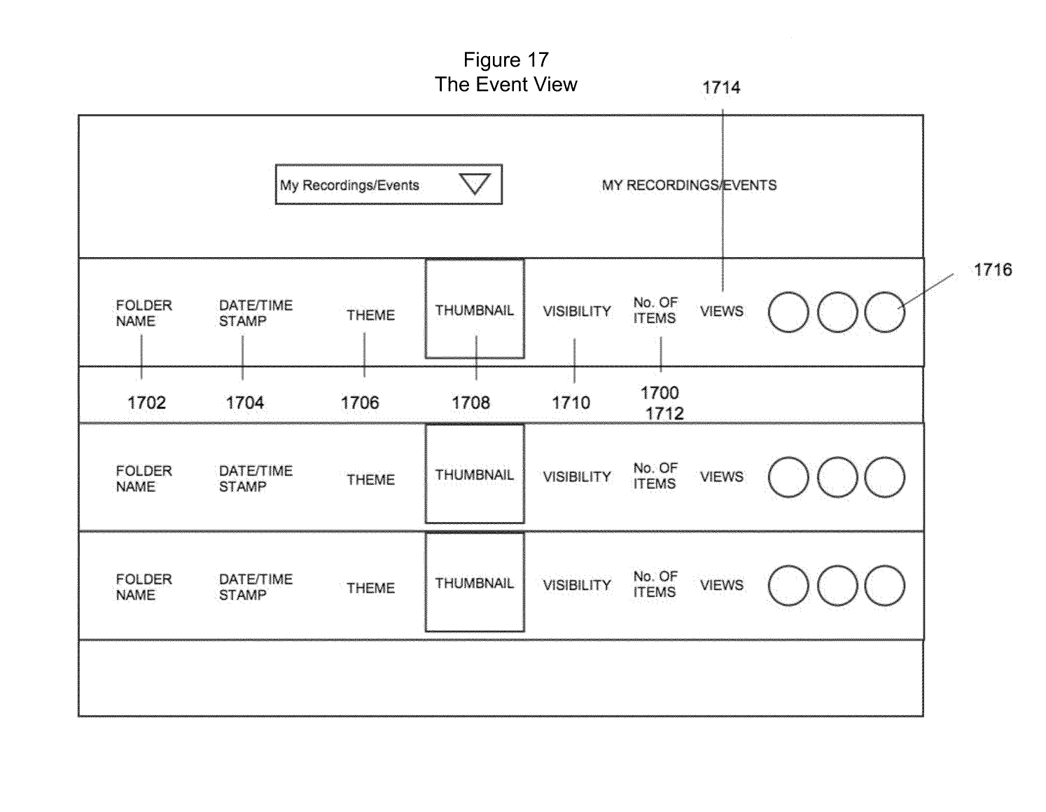

If the user is logged in to their account on the MS then an additional ‘events’ view is provided. This view allows them to create, delete and manage private and public folders. An example of the events view is shown in FIG. 17. There is an entry for every folder which includes the following information: the folder name (1702); the date and time it was created (1704); the folder's theme (1706), any image associated with the theme (1708), when and where the folder is visible on phones (1710 & 1712); the number of items in the folder (1714); the number of times the folder has been viewed (1714) and a series of action buttons (1716). The action buttons include: view, which navigates to the folder; email, which allows you to send a link to the folder via email; edit, which allows you to view and adjust folder details; and delete, which allows the user to delete the selected folder.

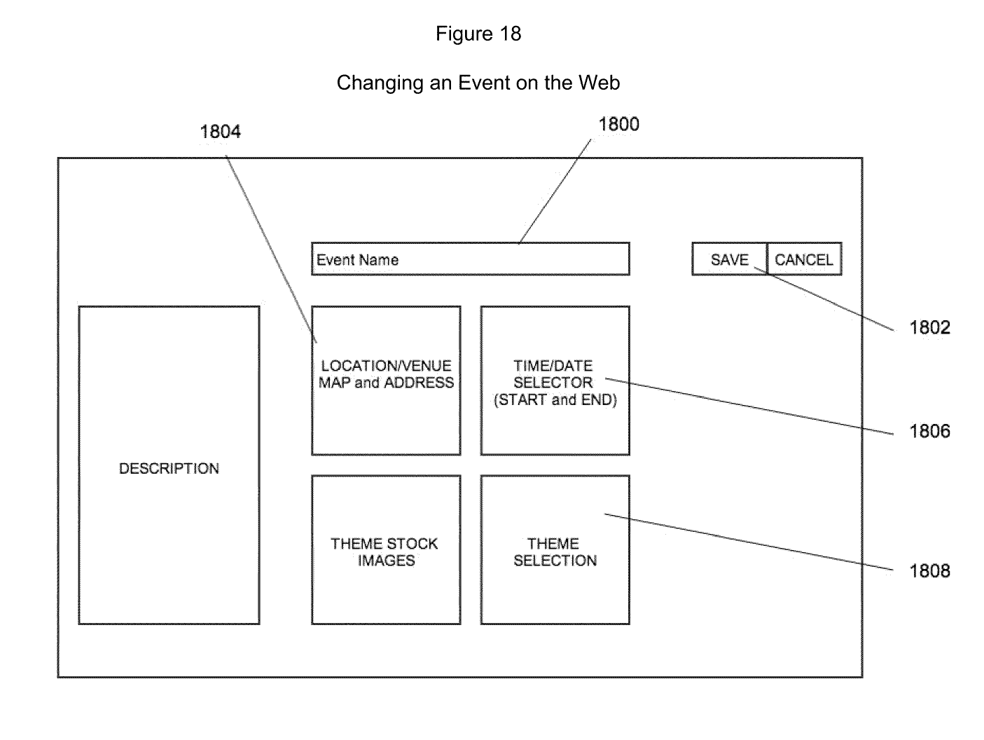

If the user chooses to create a new folder or edit an existing one the create/edit folder view may be displayed. An example of this view is shown in FIG. 18. The create event view on the Web is analogous to the MPA create folder view described above but it has more features. The user can: choose a title for the Folder (1800); adjust the appearance time and date of the folder precisely (1806); can choose an exact location for the folder (1804); can choose a theme for the folder (1808); and can set a password on the folder, if desired (not shown). This password is prompted for whenever a user tries to view the folder on the MPA or Web.

Account Management

If a user has an account on the MS they may want to adjust its settings. The MS therefore provides an account management view within the Website. In the account management view the user may adjust various account settings, such as their username and password. If the user forgets their password they can reset it on the sign-in screen and then change it here.

Settings

The MPA may provide a settings view where the user can adjust their credentials and adjust the behavior of the MPA. In particular the settings a user can adjust may include at least the following: their username and password; the default title for their recordings, the maximum length of video recordings (e.g. 15, 30, 60 or 120 seconds); whether their recordings are publicly searchable and whether to save pictures and/or videos created their MPA in the phone's gallery.

The present invention has been described in accordance with the embodiments shown, and one of ordinary skill in the art will readily recognize that there could be variations to the embodiments, and any variations would be within the spirit and scope of the present invention. Accordingly, many modifications may be made by one of ordinary skill in the art without departing from the spirit and scope of the appended claims.

We claim:

1. A computer-implemented method for estimating a skew between a first clock in a first computer system and a second clock in a second computer system, the method comprising:
sending a request from the first computer system to the second computer system, the request including a guessed value of the second clock when the request is received;
receiving at the first computer system a response from the second computer system, the response including an actual value of the second clock when the request is received and a difference between the guessed value and the actual value;
repeating the steps of sending the request with an updated guessed value and receiving the response with an updated actual value and an updated difference between the updated guessed value and the updated actual value;
measuring a mean roundtrip time for each of the request and response; and
determining the clock skew based on the mean roundtrip time, the difference between the actual value and a time at which the response is received at the first computer system.

2. A computer-implemented method for estimating a skew between a first clock in a first computer system and a second clock in a second computer system, the method comprising:
receiving a request from the first computer system at the second computer system, the request including a guessed value of the second clock when the request is received;
sending to the first computer system a response from the second computer system, the response including an actual value of the second clock when the request is received and a difference between the guessed value and the actual value;
repeating the steps of sending the request with an updated guessed value and receiving the response with an updated actual value and an updated difference between the updated guessed value and the updated actual value;
measuring a mean roundtrip time for each of the request and response; and
determining the clock skew based on the mean roundtrip time, the difference between the actual value and a time at which the response is received at the first computer system.
